(19) United States
(12) Patent Application Publication
(10) Pub. No.: US 2024/0097388 A1
(43) Pub. Date: Mar. 21, 2024

(54) EXTENSION SOCKET AND GROUND-ELECTRODE CONDUCTIVE STRUCTURE THEREOF

(71) Applicant: POWERTECH INDUSTRIAL CO., LTD., New Taipei City (TW)

(72) Inventor: JUNG-HUI HSU, New Taipei City (TW)

(21) Appl. No.: 18/210,701

(22) Filed: Jun. 16, 2023

(30) Foreign Application Priority Data
Sep. 15, 2022 (TW) 111210039

(51) Int. Cl. H01R 35/04; H01R 24/22; H01R 25/00

(52) U.S. Cl. CPC H01R 35/04; H01R 24/22; H01R 25/003; H01R 2103/00

(57) ABSTRACT

An extension socket capable of rotation and a ground-electrode conductive structure thereof are provided. The ground-electrode conductive structure includes at least two ground-electrode conductive units. Each of the at least two ground-electrode conductive units has a ground-electrode clamping portion and a ground-electrode connecting portion formed by extending from an end of the ground-electrode clamping portion. A ground-electrode pivot portion is disposed at an end of each of the ground-electrode connecting portions away from the ground-electrode clamping portion. The at least two ground-electrode conductive units are pivotally connected with each other through the ground-electrode pivot portions of two adjacent ones of the ground-electrode connecting portions.

### CROSS-REFERENCE TO RELATED PATENT APPLICATION

This application claims the benefit of priority to Taiwan Patent Application No. 111210039, filed on Sep. 15, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an extension socket, and more particularly to an extension socket capable of rotation and a ground-electrode conductive structure thereof.

### BACKGROUND OF THE DISCLOSURE

In the age of technology, electricity is indispensable in everyday life. While there is the demand for multiple power sources, it is not possible to have built-in power sockets everywhere in buildings. With the advancement of electrical apparatuses, essential household appliances have also increased in number, but there are not enough sockets available for use. Therefore, using additional extension sockets that have a plurality of jacks for connection with the utility power is the most basic solution. However, the jacks on the existing extension sockets are all oriented in the same direction. Under normal circumstances, the multiple jacks on the extension socket can all be effectively used, such that multiple plugs can be plugged into the jacks of the extension socket at the same time. Nevertheless, in recent years, an outer appearance of the plugs has diversified according to different brands. Moreover, some plugs have a rectiformer to convert AC power from the utility power into DC power that meets the use specification. As a result, the size and shape of the plug may affect the space available for an adjacent socket. If the plug that has the rectiformer or has a large size is plugged into the extension socket, the rectiformer or a housing of the plug may cover the jack of the adjacent socket. This can result in the plug or the rectiformer of another electrical appliance not being able to be plugged into the covered jack, thereby reducing a utilization rate of the extension socket. In addition, the electrical appliances plugged into the same extension socket do not all come from the same direction, and the extension socket may be accessed by plugs of indoor electrical appliances from different directions. If the direction of the plug of one electrical appliance is different from that of a plug on the socket, the plug of the electrical appliance needs to be twisted and bent for being smoothly connected into the jack. After long-term use, a wire that is twisted and bent is prone to breakage, which may result in an open circuit or electrical fires. Such danger is indeed a major electrical safety issue.

Patent No. CN209374823U discloses a rotary socket, which is structurally designed to have multiple socket units that can rotate independently. However, in this patent, a conductive structure of the socket unit is overly complicated in design, and such complexity can result in problems that include assembly difficulties and high manufacturing costs.

### SUMMARY OF THE DISCLOSURE

In response to the above-referenced technical inadequacies, the present disclosure provides an extension socket and a ground-electrode conductive structure thereof.

In one aspect, the present disclosure provides an extension socket, which includes: at least two socket casings and a conductive assembly. The at least two socket casings are serially connected with each other and each have an accommodation space. Each of the at least two socket casings is able to independently rotate along a rotation axis. The conductive assembly includes: a first conductive structure, a second conductive structure, and a ground-electrode conductive structure. The first conductive structure has a first conductive bar and at least two first clamping portions formed by extending from a side of the first conductive bar. The first conductive bar penetrates through the accommodation spaces of the at least two socket casings, and the at least two first clamping portions are disposed in the accommodation spaces of the at least two socket casings, respectively. The second conductive structure has a second conductive bar and at least two second clamping portions formed by extending from a side of the second conductive bar. The second conductive bar penetrates through the accommodation spaces of the at least two socket casings, and is arranged in parallel to the first conductive bar. The at least two second clamping portions are disposed in the accommodation spaces of the at least two socket casings, respectively. The ground-electrode conductive structure includes at least two ground-electrode conductive units. The at least two ground-electrode conductive units are respectively disposed in the accommodation spaces of the at least two socket casings, and each of the at least two ground-electrode conductive units has a ground-electrode clamping portion and two ground-electrode connecting portions formed by extending respectively from two ends of the ground-electrode clamping portion. A ground-electrode pivot portion is disposed at an end of each of the ground-electrode connecting portions away from the ground-electrode clamping portion, and the at least two ground-electrode conductive units are serially and pivotally connected with each other through the ground-electrode pivot portions of two adjacent ones of the ground-electrode connecting portions. In the accommodation space of each of the socket casings, the first clamping portion and the second clamping portion are spaced apart from each other and do not rotate with the socket casing, and the ground-electrode conductive unit surrounds the first clamping portion and the second clamping portion and is rotatable with the socket casing.

In another aspect, the present disclosure provides a ground-electrode conductive structure of an extension socket, which includes at least two ground-electrode conductive units. Each of the at least two ground-electrode conductive units has a ground-electrode clamping portion and a ground-electrode connecting portion formed by extending from an end of the ground-electrode clamping portion, and a ground-electrode pivot portion is disposed at an end of each of the ground-electrode connecting portions away from the ground-electrode clamping portion. The at least two ground-electrode conductive units are pivotally connected with each other through the ground-electrode pivot portions of two adjacent ones of the ground-electrode connecting portions.

Therefore, in the extension socket provided by the present disclosure, by virtue of “a ground-electrode conductive structure including at least two ground-electrode conductive units, in which each of the at least two ground-electrode conductive units has a ground-electrode clamping portion and a ground-electrode connecting portion formed by extending from an end of the ground-electrode clamping portion, and a ground-electrode pivot portion is disposed at an end of each of the ground-electrode connecting portions away from the ground-electrode clamping portion” and “the at least two ground-electrode conductive units being pivotally connected with each other through the ground-electrode pivot portions of two adjacent ones of the ground-electrode connecting portions,” a connection configuration of the conductive assembly in the extension socket can be simplified, thereby reducing manufacturing costs of the extension socket and achieving effects of easy assembly.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an extension socket according to a first embodiment of the present disclosure;

FIG. 2 is a schematic exploded view of the extension socket according to the first embodiment of the present disclosure;

FIG. 3 is a schematic exploded view (1) of partial components of the extension socket of FIG. 1;

FIG. 4 is a schematic exploded view (2) of partial components of the extension socket of FIG. 1;

FIG. 5A is a schematic perspective view of a first conductive structure after formation according to the first embodiment of the present disclosure, and FIG. 5B is a schematic view showing an unfolded state (before formation) of FIG. 5A;

FIG. 6A is a schematic perspective view of a second conductive structure after formation according to the first embodiment of the present disclosure, and FIG. 6B is a schematic view showing an unfolded state (before formation) of FIG. 6A;

FIG. 7 is a schematic perspective view of a ground-electrode conductive structure according to the first embodiment of the present disclosure;

FIG. 8 shows a variation form of the first conductive structure according to the first embodiment of the present disclosure;

FIG. 9 is a schematic view showing a use status of the extension socket according to the first embodiment of the present disclosure;

FIG. 10 is a schematic perspective view of the extension socket according to a second embodiment of the present disclosure;

FIG. 11 is a schematic exploded view of the extension socket according to the second embodiment of the present disclosure;

FIG. 12 is a schematic exploded view (1) of partial components of the extension socket of FIG. 10;

FIG. 13 is a schematic exploded view (2) of partial components of the extension socket of FIG. 10;

FIG. 14 is a schematic exploded view (3) of partial components of the extension socket of FIG. 10; and

FIG. 15 is a schematic perspective view of an insulating support assembly according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

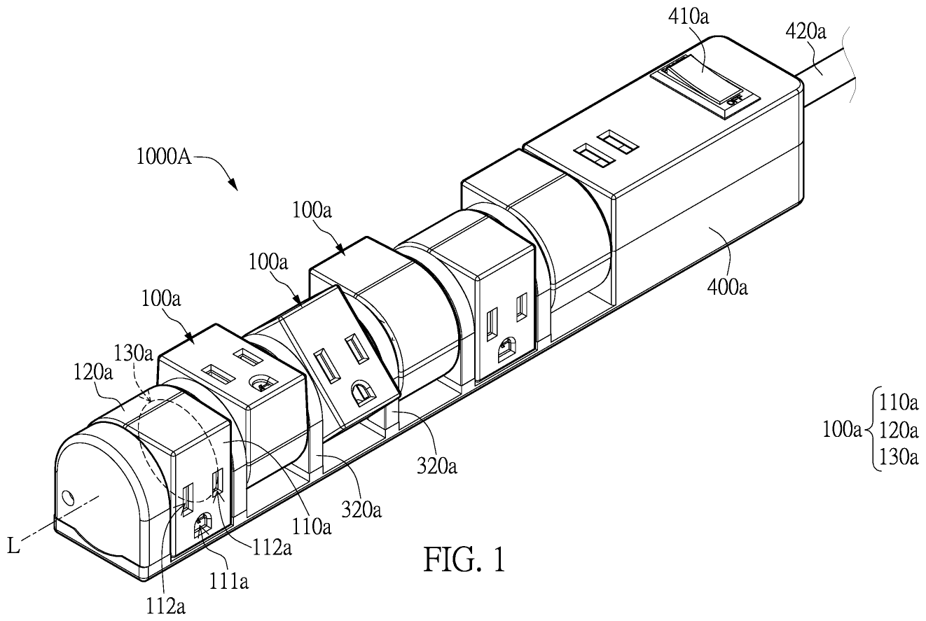

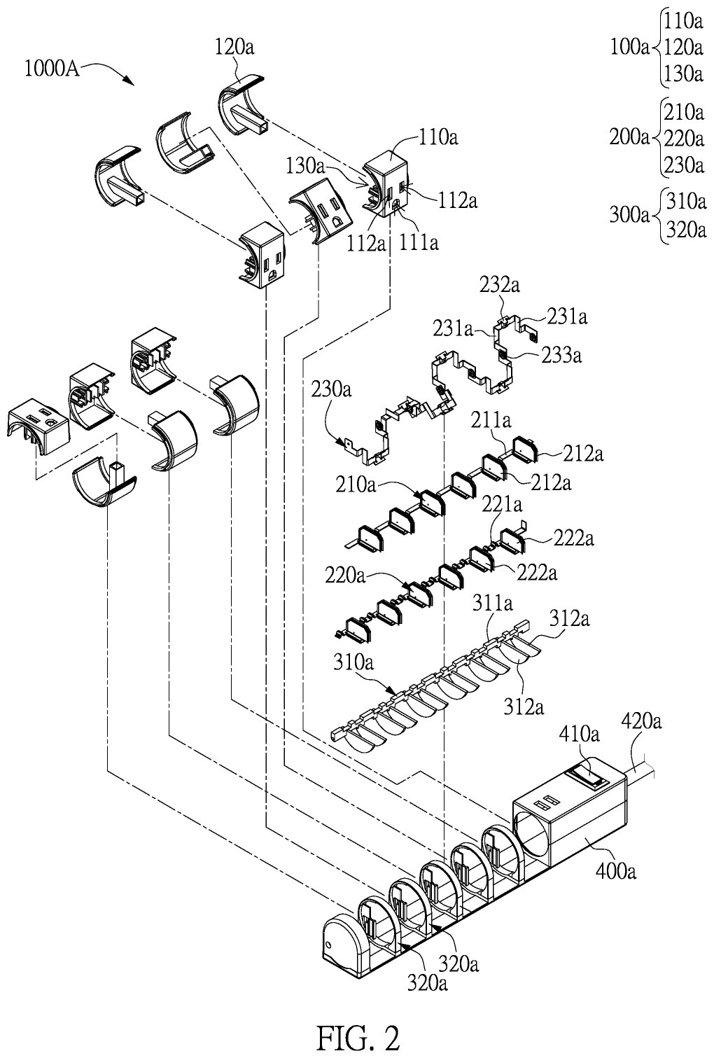

As shown in FIG. 1 and FIG. 2, a first embodiment of the present disclosure provides an extension socket 1000A, which includes at least two socket casings 100a that are serially connected with each other. A quantity of the socket casings 100a can be, for example, two or more. Six socket casings 100a that are serially connected with each other are exemplified in the present embodiment, but the present disclosure is not limited thereto. Moreover, each of the socket casings 100a is independently rotatable along a rotation axis L at a predetermined angle (e.g., from 0° to 180°).

Each of the socket casings 100a includes an upper socket casing 110a and a lower socket casing 120a, and three jacks (e.g., a ground wire jack 111a, a live wire jack 112a, and a neutral wire jack 112a) are disposed on a surface of the upper socket casing 110a. The upper socket casing 110a and the lower socket casing 120a can be fixed to each other (e.g., by insertion or clamping) and define a ring-shaped accommodation space 130a. Moreover, the accommodation spaces 130a of two adjacent ones of the socket casings 100a are in spatial communication with each other.

The extension socket 1000A further includes a conductive assembly 200a, an insulating support assembly 300a, and a socket base 400a. The conductive assembly 200a includes a first conductive structure 210a, a second conductive structure 220a, and a ground-electrode conductive structure 230a.

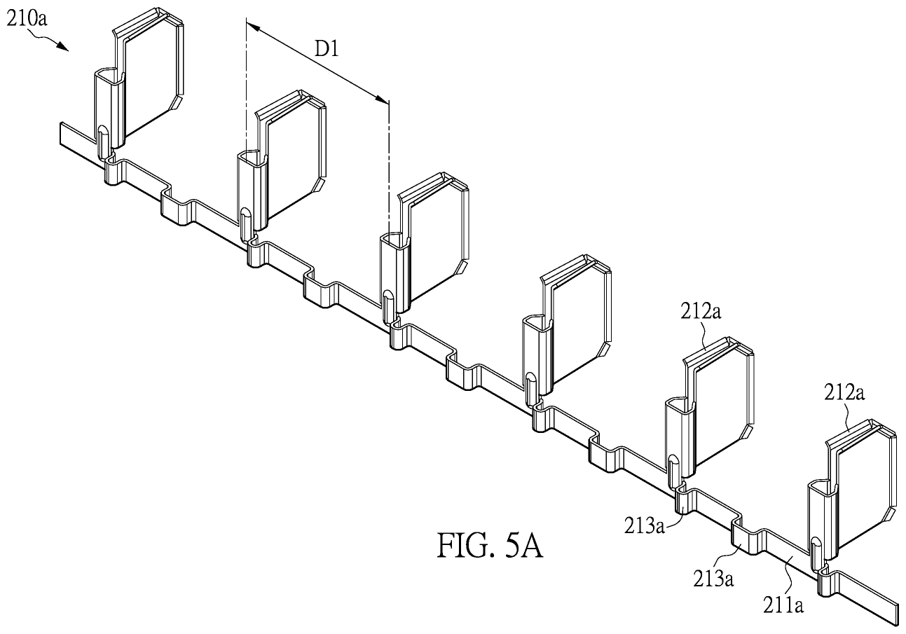

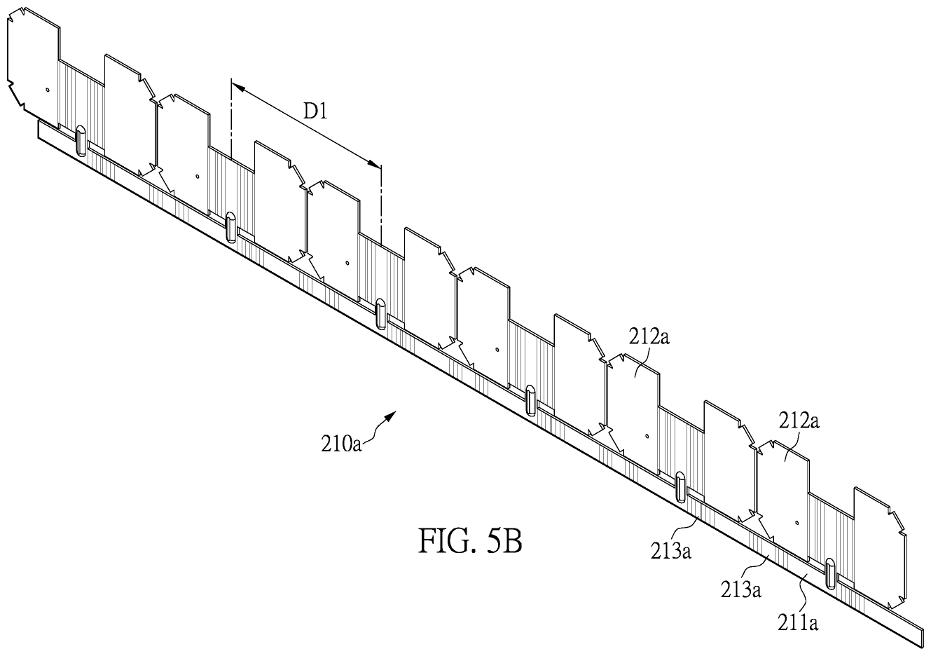

Referring to FIG. 2 to FIG. 4, which are to be read in conjunction with FIG. 5A and FIG. 5B, the first conductive structure 210a has a first conductive bar 211a and at least two first clamping portions 212a. The at least two first clamping portions 212a are spaced apart from each other, and are formed by separately extending from a side of the first conductive bar 211a. During assembly, the first conductive bar 211a penetrates through the accommodation spaces 130a of the at least two socket casings 100a. The at least two first clamping portions 212a correspond in quantity to the at least two socket casings 100a, and the at least two first clamping portions 212a are disposed in the accommodation spaces 130a of the at least two socket casings 100a, respectively. That is to say, one first clamping portion 212a is correspondingly disposed in the accommodation space 130a of each socket casing 100a. In this embodiment, the first conductive bar 211a has at least one first concave-convex microstructure 213a along its length direction, and each of the first clamping portions 212a is formed by two conductive metal copper sheets (as shown in FIG. 5). More specifically, as shown in FIG. 5B, when the first conductive structure 210a is in an unfolded state (before formation), the two conductive metal copper sheets of each first clamping portion 212a are in a flattened state, and the at least one first concave-convex microstructure 213a on the first conductive bar 211a is also in the flattened state. As shown in FIG. 5A, after the first conductive structure 210a is formed, the two conductive metal copper sheets of each first clamping portion 212a are in a folded state (for plugging of a plug), and the at least one first concave-convex microstructure 213a on the first conductive bar 211a is in a bent state. It is worth mentioning that, in the first conductive structure 210a, a shortest distance D1 between two adjacent ones of the first clamping portions 212a can be determined by the state of the at least one first concave-convex microstructure 213a. When the shortest distance D1 between two adjacent ones of the first clamping portions 212a is to be reduced, the first conductive structure 210a is configured so that the at least one first concave-convex microstructure 213a of the first conductive bar 211a is in the bent state, thereby solving the problem of the shortest distance D1 between two adjacent ones of the first clamping portions 212a being limited.

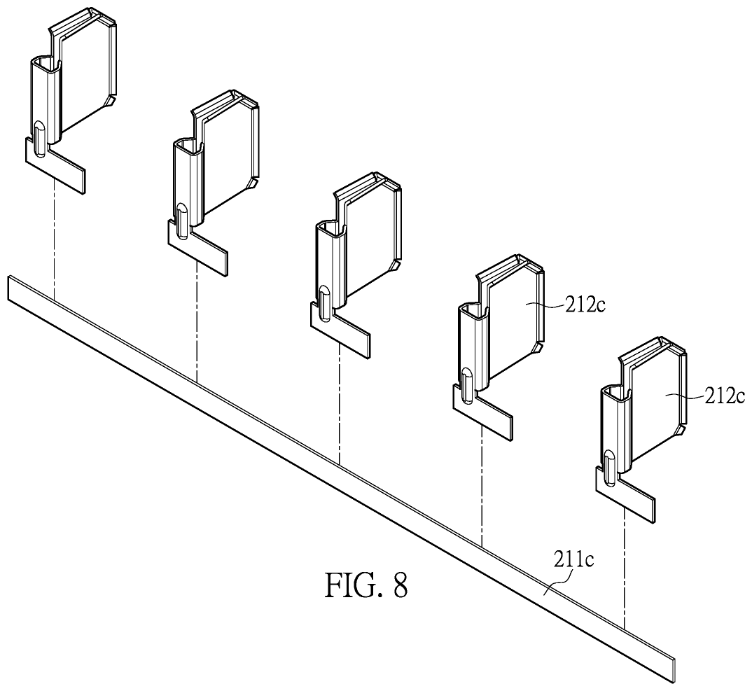

It should be noted that, in this embodiment, the at least two first clamping portions 212a and the first conductive bar 211a are integrally formed, but the present disclosure is not limited thereto. For example, as shown in FIG. 8, the at least two first clamping portions 212c can be designed to be separable from a first conductive bar 211c.

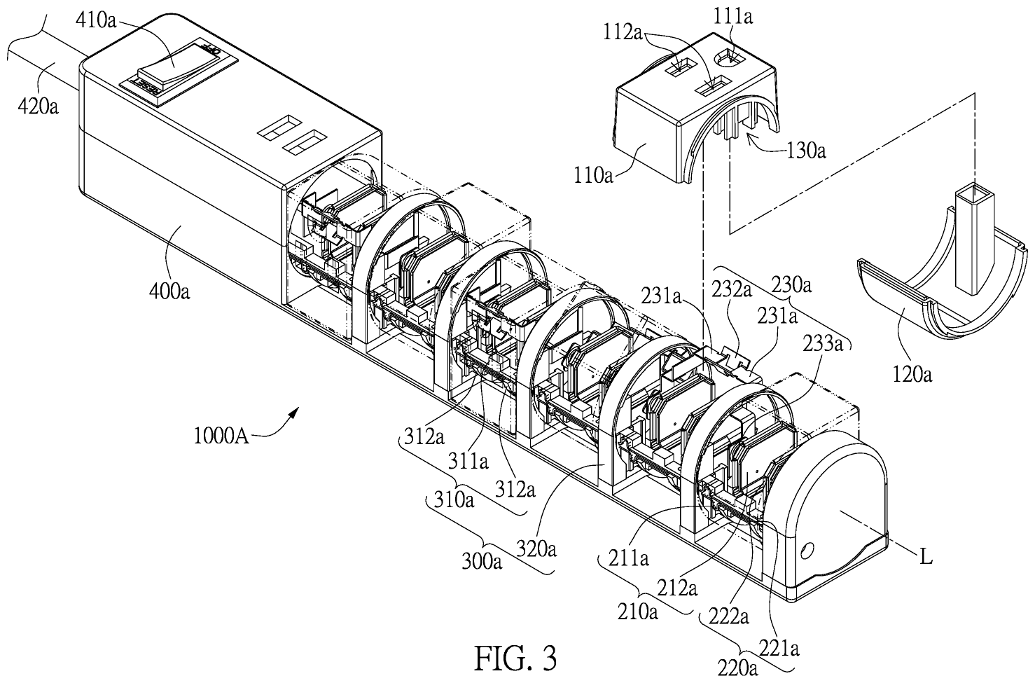

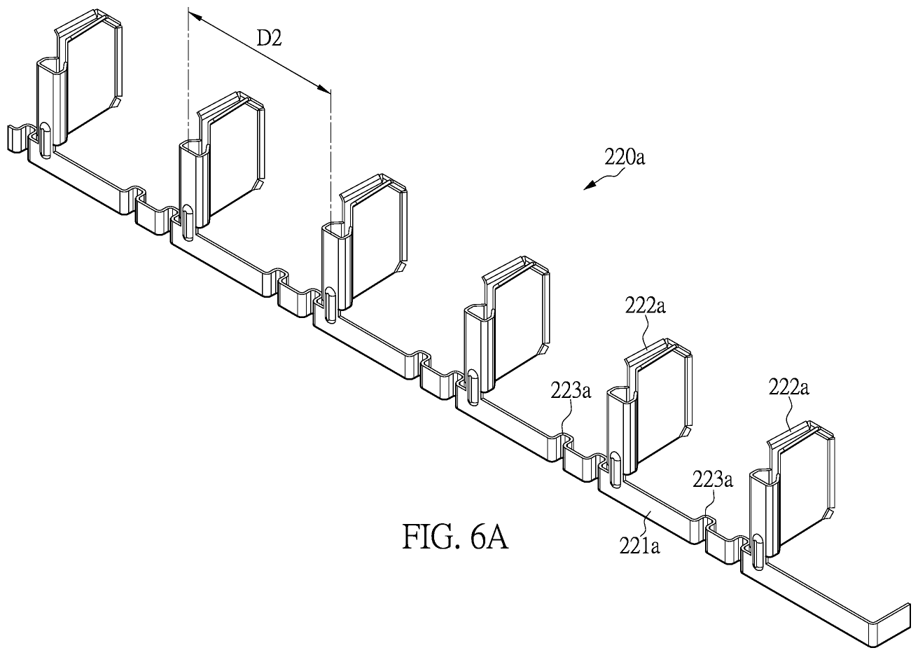

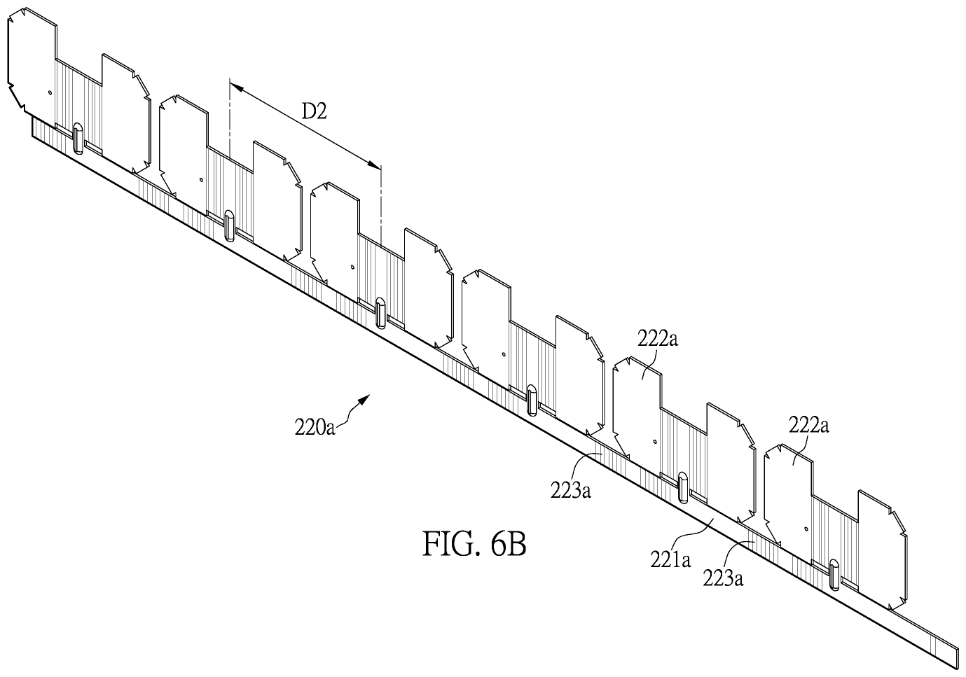

Referring to FIG. 2 to FIG. 4, which are to be read in conjunction with FIG. 6A and FIG. 6B, the second conductive structure 220a has a second conductive bar 221a and at least two second clamping portions 222a. The at least two second clamping portions 222a are spaced apart from each other, and are formed by separately extending from a side of the second conductive bar 221a. During assembly, the second conductive bar 221a penetrates through the accommodation spaces 130a of the at least two socket casings 100a, and is arranged side by side (in parallel) with the first conductive bar 211a (without directly contacting the first conductive bar 211a). The at least two second clamping portions 222a correspond in quantity to the at least two socket casings 100a, and the at least two second clamping portions 222a are disposed in the accommodation spaces 130a of the at least two socket casings 100a, respectively. That is to say, one second clamping portion 222a is correspondingly disposed in the accommodation space 130a of each socket casing 100a, and the first clamping portion 212a and the second clamping portion 222a are spaced apart from each other (as shown in FIG. 3). In this embodiment, the second conductive bar 221a has a plurality of second concave-convex microstructures 223a along its length direction, and each second clamping portion 222a is formed by two conductive metal copper sheets. More specifically, as shown in FIG. 6B, when the second conductive structure 220a is in the unfolded state (before formation), the two conductive metal copper sheets of each second clamping portion 222a are in the flattened state, and at least one of the second concave-convex microstructures 223a on the second conductive bar 221a is also in the flattened state. As shown in FIG. 6A, after the second conductive structure 220a is assembled, the two conductive metal copper sheets of each second clamping portion 222a are in the folded state (for plugging of a plug), and at least one of the second concave-convex microstructures 223a on the second conductive bar 221a is in the bent state. It is worth mentioning that, in the second conductive structure 220a, a shortest distance D2 between two adjacent ones of the second clamping portions 222a can be determined by the state of at least one of the second concave-convex microstructures 223a. When the shortest distance D2 between two adjacent ones of the second clamping portions 222a is to be reduced, the second conductive structure 220a is configured so that at least one of the second concave-convex microstructures 223a of the second conductive bar 221a is in the bent state, thereby solving the problem of the shortest distance D2 between two adjacent ones of the second clamping portions 222a being limited.

In this embodiment, the first conductive structure 210a is a conductive structure electrically connected to a neutral wire, and the second conductive structure 220a is a conductive structure electrically connected to a live wire, but the present disclosure is not limited thereto. The first conductive structure 210a can also be, for example, a conductive structure electrically connected to the live wire. Further, the second conductive structure 220a can also be, for example, a conductive structure electrically connected to the neutral wire.

It is worth mentioning that, during operation, the first conductive bar 211a and the second conductive bar 221a are both fixedly disposed in the accommodation spaces 130a of the at least two socket casings 100a. When any one of the socket casings 100a rotates, the first clamping portion 212a and the second clamping portion 222a disposed in the socket casing 100a both remain stationary and do not rotate with the socket casing 100a.

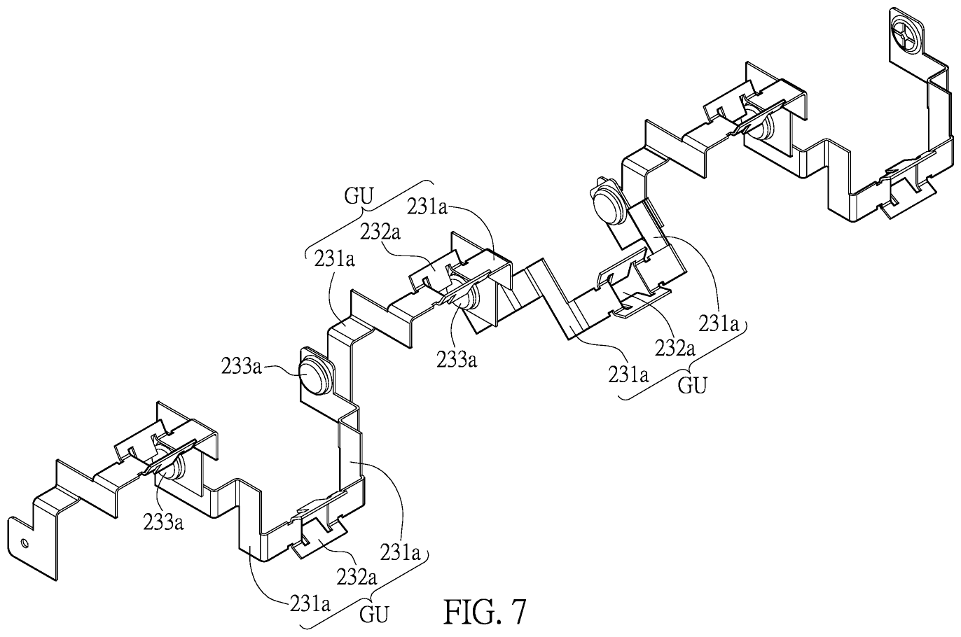

Referring to FIG. 2 to FIG. 4, which are to be read in conjunction with FIG. 7, the ground-electrode conductive structure 230a is a conductive structure electrically connected to a ground wire, and includes at least two ground-electrode conductive units GU that are serially connected with each other. Each of the ground-electrode conductive units GU has two ground-electrode connecting portions 231a and a ground-electrode clamping portion 232a, and the two ground-electrode connecting portions 231a respectively and integrally extend from two ends of the ground-electrode clamping portion 232a. The two ground-electrode connecting portions 231a and the ground-electrode clamping portion 232a substantially form a U-shaped structure, and a ground-electrode pivot portion 233a is disposed at an end of each ground-electrode connecting portion 231a away from the ground-electrode clamping portion 232a.

In any two serially-connected and adjacent ones of the ground-electrode conductive units GU, through the ground-electrode pivot portion 233a of the ground-electrode connecting portion 231a at its one side, one of the ground-electrode conductive units GU is pivoted (e.g., by a rivet) to the ground-electrode pivot portion 233a of the ground-electrode connecting portion 231a at one side of another one of the ground-electrode conductive units GU. That is to say, the at least two ground-electrode conductive units GU are serially and pivotally connected with each other through the ground-electrode pivot portions 233a of the two adjacent ground-electrode connecting portions 231a. The ground-electrode pivot portion 233a of each ground-electrode connecting portion 231a is located on the rotation axis L, such that each ground-electrode conductive unit GU can rotate along the rotation axis L.

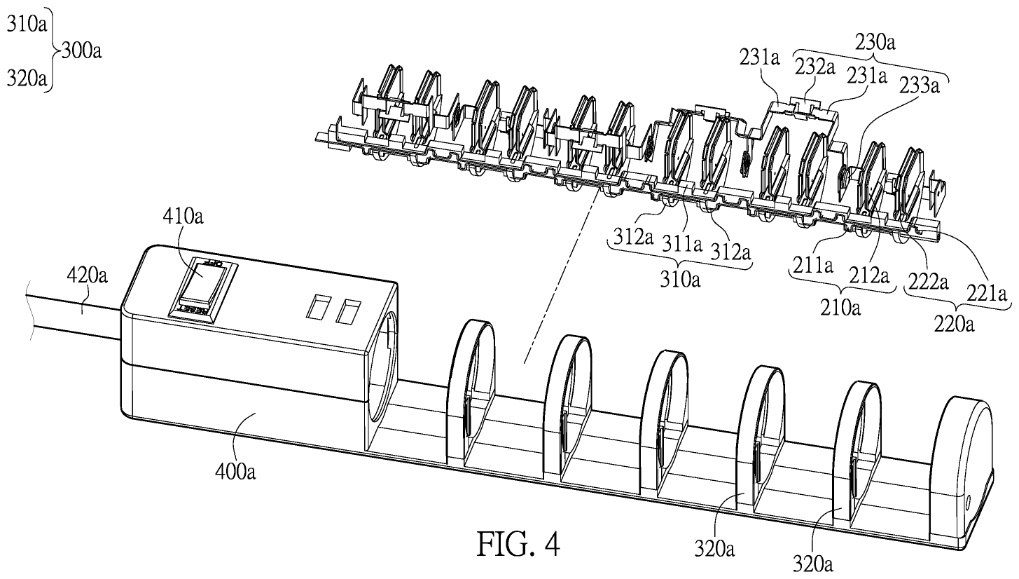

As shown in FIG. 3 and FIG. 4, the at least two ground-electrode conductive units GU correspond in quantity to the at least two socket casings 100a. During assembly, the at least two ground-electrode conductive units GU are respectively disposed in the accommodation spaces 130a of the at least two socket casings 100a, and are serially connected with each other. That is to say, one ground-electrode conductive unit GU is correspondingly disposed in the accommodation space 130a of each socket casing 100a. In the accommodation space 130a of each socket casing 100a, the ground-electrode conductive unit GU surrounds the first clamping portion 212a and the second clamping portion 222a, but is not in direct contact with the first clamping portion 212a and the second clamping portion 222a. Moreover, the ground-electrode conductive unit GU is fixedly disposed on the upper socket casing 110a or on the lower socket casing 120a of the socket casing 100a. During operation, the ground-electrode clamping portion 232a of the ground-electrode conductive unit GU rotates about the rotation axis L with the socket casing 100a, and corresponds in position to the ground wire jack 111a of the upper socket casing 110a at any time.

As shown in FIG. 3, in this embodiment, the ground-electrode pivot portions 233a of two serially-connected and adjacent ones of the ground-electrode conductive units GU are located between two of the socket casings 100a. In other words, in each ground-electrode conductive unit GU, the ground-electrode pivot portion 233a of each ground-electrode connecting portion 231a is located outside the first clamping portion 212a and the second clamping portion 222a of each socket casing 100a, and is not located between the first clamping portion 212a and the second clamping portion 222a. In addition, the ground-electrode clamping portion 232a of the ground-electrode conductive unit GU is located around the first clamping portion 212a and the second clamping portion 222a, and is not located on the rotation axis L.

Referring to FIG. 1 to FIG. 4, the first conductive structure 210a is fixedly disposed on the insulating support assembly 300a via its first conductive bar 211a, the second conductive structure 220a is fixedly disposed on the insulating support assembly 300a via its second conductive bar 221a, and the first conductive bar 211a and the second conductive bar 221a are spaced apart from each other by the insulating support assembly 300a and do not directly contact with each other. That is to say, the insulating support assembly 300a is not only capable of supporting the conductive assembly 200a, but is also used for separating the first conductive bar 211a from the second conductive bar 221a to achieve an insulation effect.

More specifically, the insulating support assembly 300a includes a fixing rack 310a and at least one spacer 320a. The fixing rack 310a and the spacer 320a are separable. In addition, a quantity of the spacers 320a in this embodiment is six, but the present disclosure is not limited thereto.

The fixing rack 310a has an elongated conductive bar fixing portion 311a and a plurality of semicircle-shaped clamping sheet fixing portions 312a. The clamping sheet fixing portions 312a are formed by respectively extending from a side of the conductive bar fixing portion 311a, and are spaced apart from each other. The conductive bar fixing portion 311a penetrates through the accommodation spaces 130a of the at least two socket casings 100a. The first conductive bar 211a and the second conductive bar 221a are fixedly disposed on and separated by the conductive bar fixing portion 311a.

In the accommodation space 130a of each socket casing 100a, the first clamping portion 212a and the second clamping portion 222a are disposed above two of the semicircle-shaped clamping sheet fixing portions 312a, respectively. That is to say, two of the clamping sheet fixing portions 312a are disposed in the accommodation space 130a of each socket casing 100a, so as to respectively fix the first clamping portion 212a and the second clamping portion 222a.

Further, the at least one spacer 320a is ring-shaped and disposed between the at least two socket casings 100a. The at least one spacer 320a is used for separating two adjacent ones of the socket casings 100a, and the socket casing 100a is configured to abut and rotate against the spacer 320a.

During assembly, the two adjacent and pivotally-connected ground-electrode pivot portions 233a are located at an inner side of the ring-shaped spacer 320a, but the present disclosure is not limited thereto. In this embodiment, the first clamping portion 212a and the second clamping portion 222a that are disposed in the accommodation space 130a of each socket casing 100a are located between two adjacent ones of the spacers 320a.

It should be noted that, during operation, the insulating support assembly 300a is a fixed and immovable component, and the first conductive structure 210a and the second conductive structure 220a are both fixedly disposed on the fixing rack 310a. When any one of the socket casings 100a rotates, similar to the insulating support assembly 300a, the first conductive structure 210a and the second conductive structure 220a remain stationary and do not rotate with the socket casing 100a. In addition, the ground-electrode clamping portion 232a of the ground-electrode conductive unit GU rotates about the rotation axis L along with the socket casing 100a, and corresponds in position to the ground wire jack 111a of the upper socket casing 110a at any time.

Reference is further made to FIG. 1 to FIG. 4. The at least two socket casings 100a are configured to be rotatably disposed on the socket base 400a. In addition, the fixing rack 310a and the spacer 320a of the insulating support assembly 300a are configured to be fixedly disposed on the socket base 400a, such that the insulating support assembly 300a is a fixed and immovable component relative to the socket casing 100a.

Moreover, a switch unit 410a and a power line 420a are further disposed on the socket base 400a.

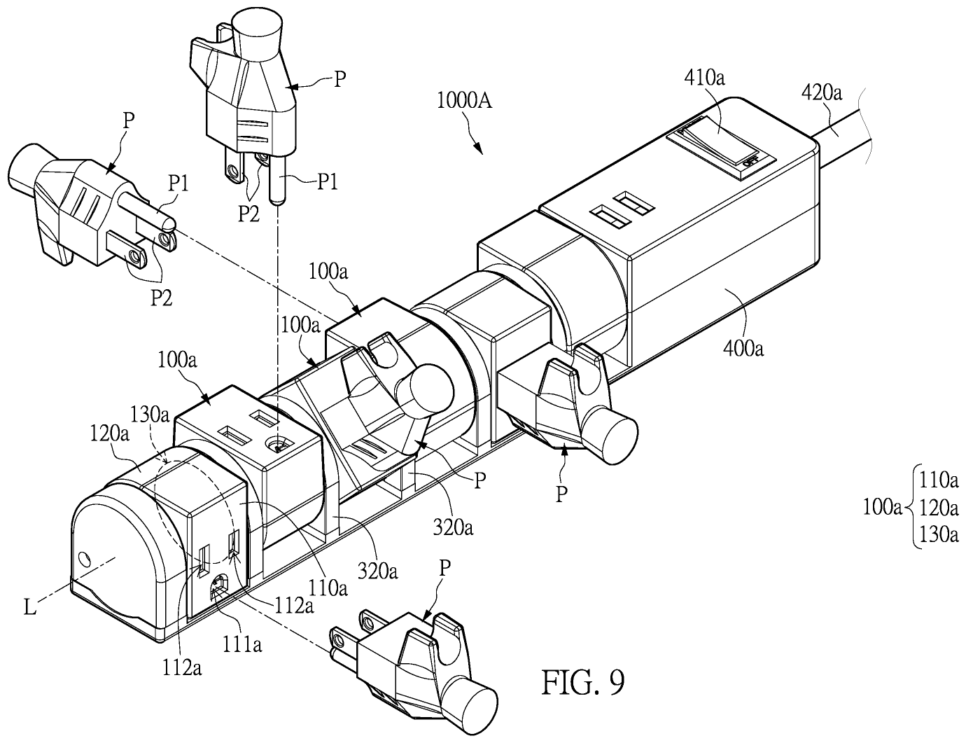

As shown in FIG. 9, during operation, each socket casing 100a rotates about the rotation axis L, and a plug P is plugged into the socket casing 100a. A ground wire pin P1 of the plug P can be inserted into the ground wire jack 111a of the socket casing 100a, and is in contact with the ground-electrode clamping portion 232a of the ground-electrode conductive unit GU. Moreover, a live wire pin P2 and a neutral wire pin P2 of the plug P can be respectively inserted into the live wire jack 112a and the neutral wire jack 112a of the socket casing 100a, and are respectively in contact with the first clamping portion 212a of the first conductive structure 210a and the second clamping portion 222a of the second conductive structure 220a.

Based on the above-mentioned configuration, the plug P is rotatable with the socket casing 100a, and can maintain an electrical connection status throughout a rotation process of the socket casing 100a.

### Second Embodiment

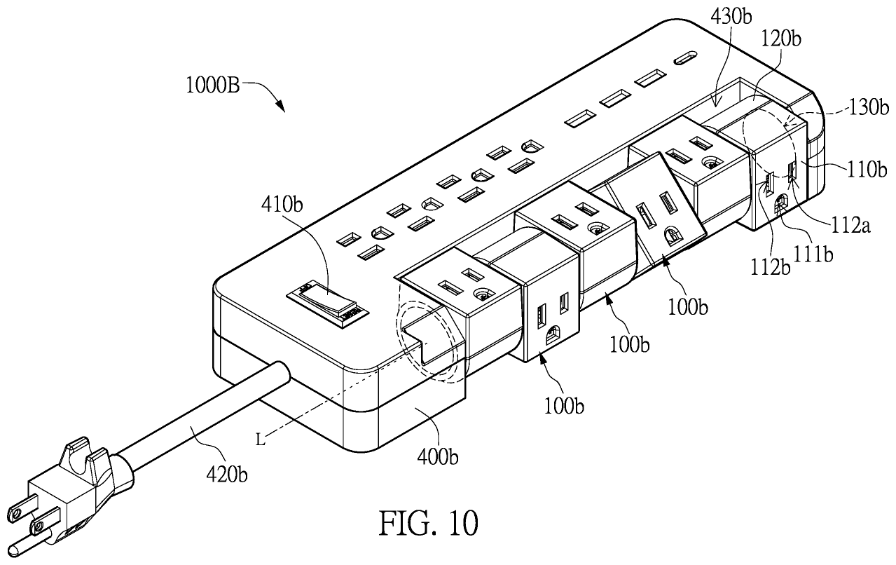

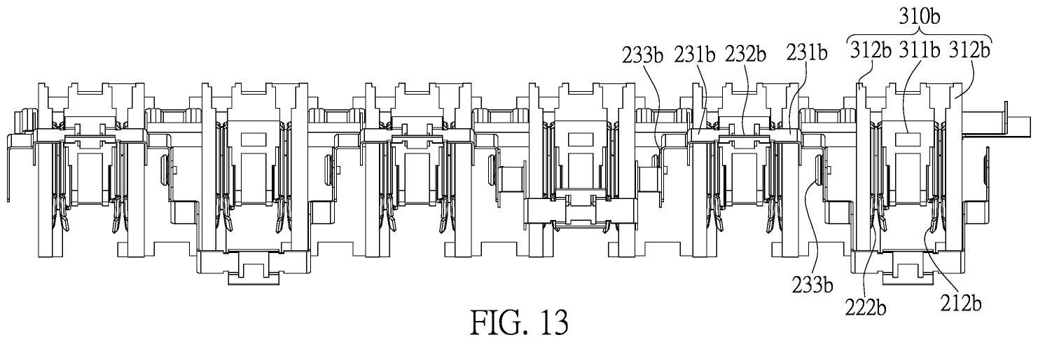

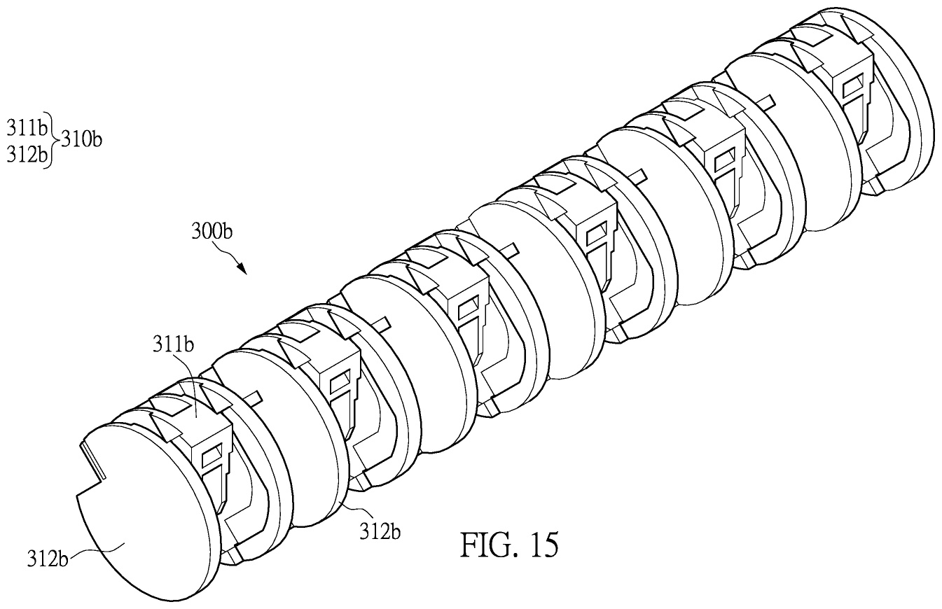

As shown in FIG. 10 to FIG. 15, a second embodiment of the present disclosure provides an extension socket 1000B. In terms of socket rotation configuration, the extension socket 1000B in the second embodiment of the present disclosure is substantially the same as the extension socket 1000A in the first embodiment. Their difference mainly resides in that a socket base 400b of this embodiment further has a limiting space 430b, such that a socket casing 100b disposed at an inner side of the limiting space 430b is limited to rotating within a predetermined angle (e.g., from 0° to 90°).

Moreover, no spacer 320a of the first embodiment is disposed between at least two socket casings 100b of this embodiment (which are adjoined to one another). There are also some differences between an insulating support assembly 300b in this embodiment and the insulating support assembly 300a in the first embodiment in terms of structural design.

More specifically, the at least two socket casings 100b included in the extension socket 1000B of this embodiment are serially connected with each other. Each of the socket casings 100b is independently rotatable at the inner side of the limiting space 430b along the rotation axis L within the predetermined angle (e.g., from 0° to 90°).

Each of the socket casings 100b includes an upper socket casing 110b and a lower socket casing 120b, and three jacks (e.g., a ground wire jack 111b, a live wire jack 112b, and a neutral wire jack 112b) are disposed on a surface of the upper socket casing 110b. The upper socket casing 110b and the lower socket casing 120b can be fixed to each other and define a ring-shaped accommodation space 130b.

The extension socket 1000B further includes a conductive assembly 200b, an insulating support assembly 300b, and a socket base 400b. The conductive assembly 200b includes a first conductive structure 210b, a second conductive structure 220b, and a ground-electrode conductive structure 230b.

The first conductive structure 210b has a first conductive bar 211b and at least two first clamping portions 212b. The at least two first clamping portions 212b are spaced apart from each other, and are formed by separately extending from a side of the first conductive bar 211b. The second conductive structure 220b has a second conductive bar 221b and at least two second clamping portions 222b. The at least two second clamping portions 222b are spaced apart from each other, and are formed by separately extending from a side of the second conductive bar 221b.

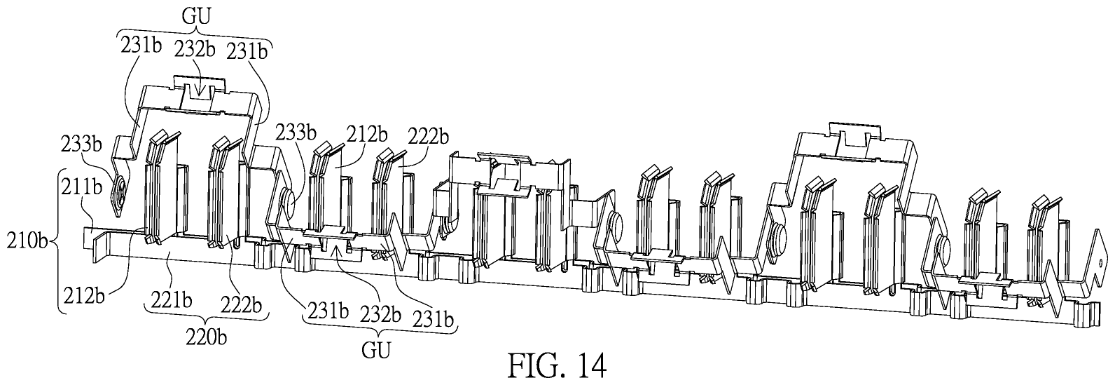

As shown in FIG. 14, the ground-electrode conductive structure 230b includes at least two ground-electrode conductive units GU that are serially connected with each other. Each of the ground-electrode conductive units GU has two ground-electrode connecting portions 231b and a ground-electrode clamping portion 232b, and the two ground-electrode connecting portions 231b respectively and integrally extend from two ends of the ground-electrode clamping portion 232b. The two ground-electrode connecting portions 231b and the ground-electrode clamping portion 232b substantially form a U-shaped structure, and a ground-electrode pivot portion 233b is disposed at an end of each ground-electrode connecting portion 231b away from the ground-electrode clamping portion 232b.

In any two serially-connected and adjacent ones of the ground-electrode conductive units GU, through the ground-electrode pivot portion 233b of the ground-electrode connecting portion 231b at its one side, one of the ground-electrode conductive units GU is pivoted to the ground-electrode pivot portion 233b of the ground-electrode connecting portion 231b at one side of another one of the ground-electrode conductive units GU.

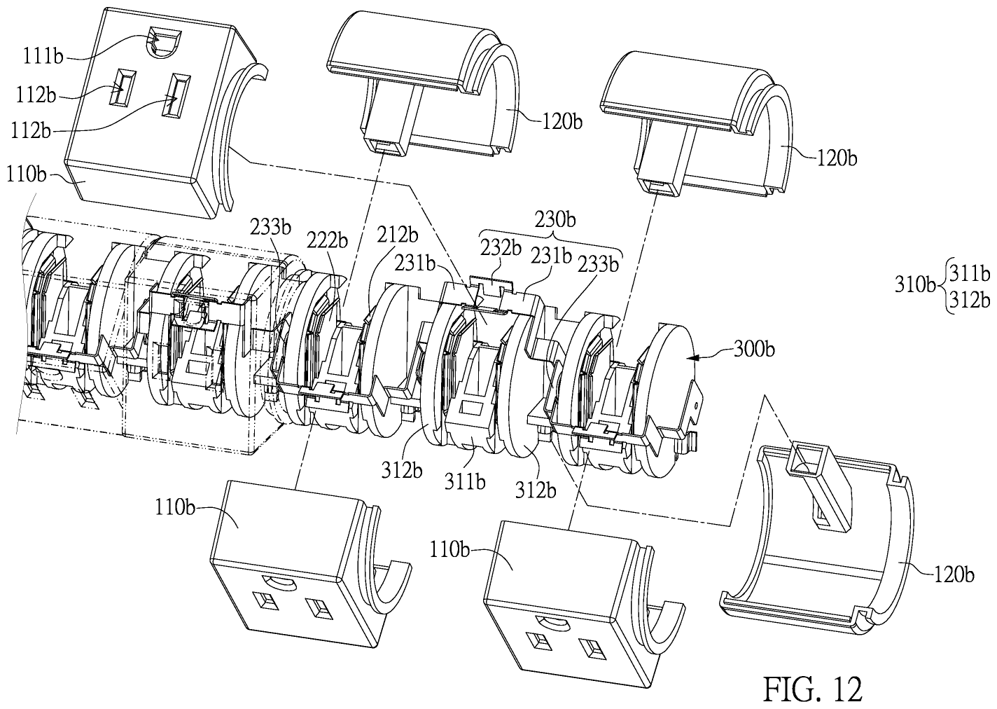

As shown in FIG. 12, in this embodiment, the ground-electrode pivot portions 233b of two serially-connected and adjacent ones of the ground-electrode conductive units GU are located between two of the socket casings 100b. That is to say, in each ground-electrode conductive unit GU, the ground-electrode pivot portion 233b of each ground-electrode connecting portion 231b is located outside the first clamping portion 212b and the second clamping portion 222b of each socket casing 100b, and is not located between the first clamping portion 212b and the second clamping portion 222b. In addition, the ground-electrode clamping portion 232b of the ground-electrode conductive unit GU is located around the first clamping portion 212b and the second clamping portion 222b, and is not located on the rotation axis L.

In this embodiment, the insulating support assembly 300b includes a fixing rack 310b, but does not include the spacer 320a of the first embodiment. The fixing rack 310b penetrates through the accommodation spaces 130b of the at least two socket casings 100b.

The fixing rack 310b includes a conductive bar fixing portion 311b and a plurality of circular clamping sheet fixing portions 312b. The conductive bar fixing portions 311b are serially connected between the clamping sheet fixing portions 312b, so as to form the fixing rack 310b. Each of the clamping sheet fixing portions 312b has a circular sheet shape. The conductive bar fixing portion 311b has an insertion structure into which the first conductive bar 211b and the second conductive bar 221b can be inserted, such that the first conductive bar 211b and the second conductive bar 221b can both be fixed on and separated by the conductive bar fixing portion 311b. In this way, an insulation effect can be produced.

The clamping sheet fixing portions 312b are spaced apart from each other. As shown in FIG. 12, in the accommodation space 130b of each socket casing 100b, the first clamping portion 212b and the second clamping portion 222b are respectively disposed at inner sides of two of the clamping sheet fixing portions 312b that have a circular sheet shape. That is to say, two of the clamping sheet fixing portions 312b are disposed in the accommodation space 130b of each socket casing 100b, and are used for fixing the first clamping portion 212b and the second clamping portion 222b, respectively.

It should be noted that, during operation, the insulating support assembly 300b is a fixed and immovable component, and the first conductive structure 210b and the second conductive structure 220b are both fixedly disposed on the fixing rack 310b. When any one of the socket casings 100b rotates, similar to the insulating support assembly 300b, the first conductive structure 210b and the second conductive structure 220b remain stationary and do not rotate with the socket casing 100b. In addition, the ground-electrode clamping portion 232b of the ground-electrode conductive unit GU rotates about the rotation axis L along with the socket casing 100b, and corresponds in position to the ground wire jack 111b of the upper socket casing 110b at any time.

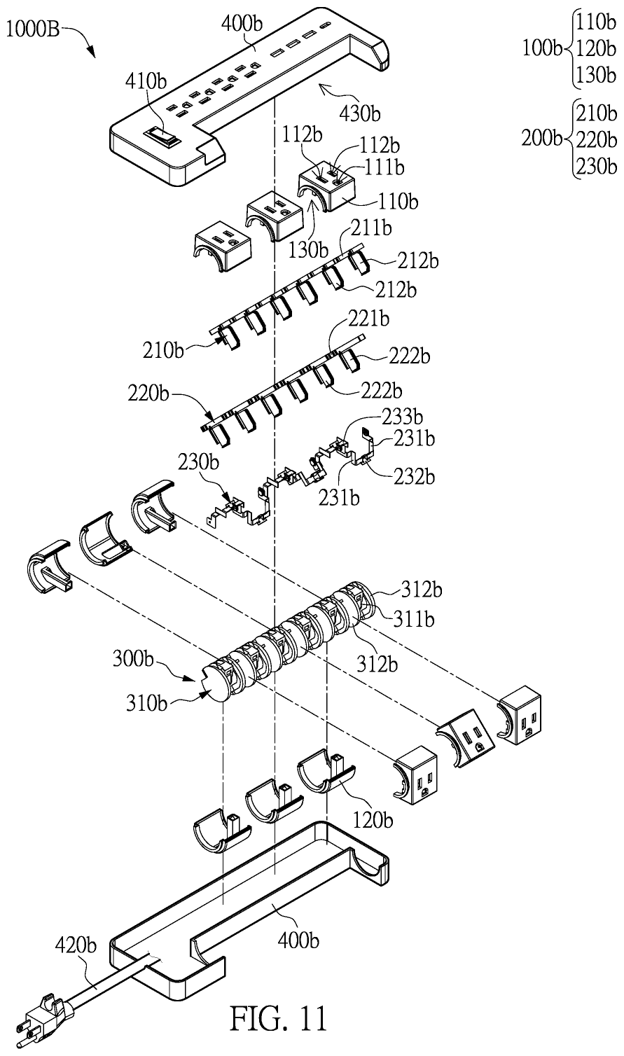

Reference is further made to FIG. 10 and FIG. 11. The socket base 400b further has the limiting space 430b, and the at least two socket casings 100b are configured to be rotatably disposed on the socket base 400b. In addition, the fixing rack 310b of the insulating support assembly 300b is configured to be fixedly disposed on the socket base 400b, such that the insulating support assembly 300b is a fixed and immovable component relative to the socket casing 100b. The socket casing 100b disposed at the inner side of the limiting space 430b is limited to rotating within the predetermined angle (e.g., from 0° to 90°). Moreover, different from the first embodiment, no spacer 320a is disposed between the at least two socket casings 100b of this embodiment (which are adjoined to one another).

Further, a switch unit 410b and a power line 420b are further disposed on the socket base 400b. During operation, each socket casing 100b rotates about the rotation axis L, and a plug P is plugged into the socket casing 100b. A ground wire pin P1 of the plug P can be inserted into the ground wire jack 111b of the socket casing 100b, and is in contact with the ground-electrode clamping portion 232b of the ground-electrode conductive unit GU. Moreover, a live wire pin P2 and a neutral wire pin P2 of the plug P can be respectively inserted into the live wire jack 112b and the neutral wire jack 112b of the socket casing 100b, and are respectively in contact with the first clamping portion 212b of the first conductive structure 210b and the second clamping portion 222b of the second conductive structure 220b. Based on the above-mentioned configuration, the plug P is rotatable with the socket casing 100b, and can maintain an electrical connection status throughout a rotation process of the socket casing 100b.

### Beneficial Effects of the Embodiments

In conclusion, in the extension socket provided by the present disclosure, by virtue of “a ground-electrode conductive structure including at least two ground-electrode conductive units, in which each of the at least two ground-electrode conductive units has a ground-electrode clamping portion and a ground-electrode connecting portion formed by extending from an end of the ground-electrode clamping portion, and a ground-electrode pivot portion is disposed at an end of each of the ground-electrode connecting portions away from the ground-electrode clamping portion” and “the at least two ground-electrode conductive units being pivotally connected with each other through the ground-electrode pivot portions of two adjacent ones of the ground-electrode connecting portions,” a connection configuration of the conductive assembly in the extension socket can be simplified, thereby reducing manufacturing costs of the extension socket and achieving effects of easy assembly.

Further, in the present disclosure, the at least two first clamping portions and the first conductive bar of the first conductive structure are integrally formed, and the at least two second clamping portions and the second conductive bar of the second conductive structure are integrally formed, thereby reducing the manufacturing costs of the conductive structures.

In addition, in the accommodation space of each socket casing, the first clamping portion and the second clamping portion are spaced apart from each other and do not rotate with the socket casing (i.e., the copper sheets are fixed and immovable and do not rotate with the socket), thereby saving costs for rivets in a rivet configuration adopted by a conventional rotary socket. Moreover, since the copper sheets are fixed, the risk of loosening a rotation shaft caused by rotation can be lowered.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An extension socket, comprising:
at least two socket casings serially connected with each other and each having an accommodation space, wherein each of the at least two socket casings is able to independently rotate along a rotation axis; and
a conductive assembly, wherein the conductive assembly includes:
a first conductive structure having a first conductive bar and at least two first clamping portions formed by extending from a side of the first conductive bar, wherein the first conductive bar penetrates through the accommodation spaces of the at least two socket casings, and the at least two first clamping portions are disposed in the accommodation spaces of the at least two socket casings, respectively;
a second conductive structure having a second conductive bar and at least two second clamping portions formed by extending from a side of the second conductive bar, wherein the second conductive bar penetrates through the accommodation spaces of the at least two socket casings, and is arranged in parallel to the first conductive bar; wherein the at least two second clamping portions are disposed in the accommodation spaces of the at least two socket casings, respectively; and
a ground-electrode conductive structure including at least two ground-electrode conductive units, wherein the at least two ground-electrode conductive units are respectively disposed in the accommodation spaces of the at least two socket casings, and each of the at least two ground-electrode conductive units has a ground-electrode clamping portion and two ground-electrode connecting portions formed by extending respectively from two ends of the ground-electrode clamping portion; wherein a ground-electrode pivot portion is disposed at an end of each of the ground-electrode connecting portions away from the ground-electrode clamping portion, and the at least two ground-electrode conductive units are serially and pivotally connected with each other through the ground-electrode pivot portions of two adjacent ones of the ground-electrode connecting portions;
wherein, in the accommodation space of each of the socket casings, the first clamping portion and the second clamping portion are spaced apart from each other and do not rotate with the socket casing, and the ground-electrode conductive unit surrounds the first clamping portion and the second clamping portion and is rotatable with the socket casing.

2. The extension socket according to claim 1, wherein the at least two first clamping portions and the first conductive bar are integrally formed, and the at least two second clamping portions and the second conductive bar are integrally formed.

3. The extension socket according to claim 1, wherein the at least two first clamping portions and the first conductive bar are separated from each other, and the at least two second clamping portions and the second conductive bar are separated from each other.

4. The extension socket according to claim 1, wherein, when any one of the socket casings rotates, the ground-electrode clamping portion disposed in the socket casing rotates about the rotation axis with the socket casing, and corresponds in position to a ground wire jack on the socket casing at any time.

5. The extension socket according to claim 1, wherein, in each of the ground-electrode conductive units, the ground-electrode pivot portion is located on the rotation axis, such that each of the ground-electrode conductive units is able to rotate along the rotation axis.

6. The extension socket according to claim 1, wherein, in each of the ground-electrode conductive units, the ground-electrode pivot portion is located outside the first clamping portion and the second clamping portion of the socket casing, and the ground-electrode conductive unit surrounds the first clamping portion and the second clamping portion.

7. The extension socket according to claim 1, further comprising an insulating support assembly, wherein the first conductive structure is fixedly disposed on the insulating support assembly via the first conductive bar, the second conductive structure is fixedly disposed on the insulating support assembly via the second conductive bar, and the first conductive bar and the second conductive bar are spaced apart from each other by the insulating support assembly and do not directly contact with each other.

8. The extension socket according to claim 7, further comprising a socket base, wherein the at least two socket casings are configured to be rotatably disposed on the socket base, and the insulating support assembly is fixedly disposed on the socket base, such that the insulating support assembly is a fixed and immovable component with respect to the socket casing.

9. The extension socket according to claim 1, wherein at least one first concave-convex microstructure is formed in the first conductive structure along a length direction of the first conductive bar, and a shortest distance between the at least two first clamping portions is determined by a state of the at least one first concave-convex microstructure of the first conductive bar; wherein, when the shortest distance between the at least two first clamping portions is to be reduced, the first conductive structure is configured so that the at least one first concave-convex microstructure is in a bent state; wherein, alternatively, at least one second concave-convex microstructure is formed in the second conductive structure along a length direction of the second conductive bar, and a shortest distance between the at least two second clamping portions is determined by a state of the at least one second concave-convex microstructure of the second conductive bar; wherein, when the shortest distance between the at least two second clamping portions is to be reduced, the second conductive structure is configured so that the at least one second concave-convex microstructure is in the bent state.

10. A ground-electrode conductive structure of an extension socket, comprising: at least two ground-electrode conductive units, wherein each of the at least two ground-electrode conductive units has a ground-electrode clamping portion and a ground-electrode connecting portion formed by extending from an end of the ground-electrode clamping portion, and a ground-electrode pivot portion is disposed at an end of each of the ground-electrode connecting portions away from the ground-electrode clamping portion; wherein the at least two ground-electrode conductive units are pivotally connected with each other through the ground-electrode pivot portions of two adjacent ones of the ground-electrode connecting portions.
